(19) United States
(12) Patent Application Publication
(10) Pub. No.: US 2012/0216382 A1
(43) Pub. Date: Aug. 30, 2012

(54) METHOD OF INSTALLING JET PUMP BEAM

(75) Inventors: Masahiro HIRATSUKA, Hitachi (JP); Minoru OOTAKA, Takahagi (JP); Masahiro KOIKE, Hitachi (JP); Hiroyuki NAKANO, Mito (JP); Akira NISHIMIZU, Tokai (JP)

(73) Assignee: Hitachi-GE Nuclear Energy, Ltd.

(21) Appl. No.: 13/367,390

(22) Filed: Feb. 7, 2012

(30) Foreign Application Priority Data
Feb. 28, 2011 (JP) 2011-041439

(51) Int. Cl. B23P 11/00

(52) U.S. Cl. 29/407.05; 29/407.01

(57) ABSTRACT

A method of installing a jet pump beam includes, disposing an inlet mixer having one end portion inserted to a diffuser provided in a reactor pressure vessel and an other end portion communicated with a riser pipe disposed in the reactor pressure vessel between a pair of projecting portions of a transition piece provided to the riser pipe, separately inserting both end portions of a jet pump beam disposed above the inlet mixer into a groove formed in each of the pair of projecting portions, arching the jet pump beam by moving a center portion of the jet pump beam upward, pushing a screw member engaged with the arched jet pump beam against the inlet mixer, and measuring deflection amount of the arched jet pump beam when the screw member is being pushed against the inlet mixer.

### CLAIM OF PRIORITY

The present application claims priority from Japanese Patent application serial no. 2011-41439, filed on Feb. 28, 2011, the content of which is hereby incorporated by reference into this application.

### BACKGROUND OF THE INVENTION

1. Technical Field

The present invention relates to a method of installing a jet pump beam and, in particular, to a method of installing a jet pump beam suitable for applying to a boiling water reactor.

2. Background Art

A boiling water reactor is provided with a plurality of jet pumps disposed in a downcomer which is an annular region formed between a reactor pressure vessel (hereinafter, referred to as an RPV) connected with a recirculation pipe and a cylindrical core shroud surrounding a core in the RPV. The jet pumps include an elbow, a nozzle, a bell mouth, a throat, and a diffuser. Cooling water pressurized by drive of a recirculation pump flows through the recirculation pipe, and as driving water, passes through a riser pipe, a transition piece, and the elbow, and is ejected from the nozzle into the bell mouth and the throat. The nozzle increases speed of the driving water. The cooling water around the nozzle in the downcomer is sucked into the throat as suction water by action of the ejected driving water, and flows into the diffuser as exchanging kinetic momentum with the driving water in the throat. The cooling water discharged from the diffuser is supplied to the core through a lower plenum in the RPV.

The jet pump installed in the reactor pressure vessel has an inlet mixer including the elbow, the nozzle, the bell mouth, and the throat joined together as a single-piece construction, removable for inspection and repair. The driving water that ascended in the riser pipe changes its flowing direction 180° by the elbow and flows into the nozzle of the jet pump as a downward flow. As a result, a top face of the elbow is held down by a jet pump beam (hereinafter, simply referred to as a beam) because upward force exerted by a flowing fluid is applied to the elbow. The beam has both end portion inserted into a groove formed in each of a pair of projecting portions extending upward from a transition piece connected to a top portion of the riser pipe, and the beam is kept in a deflection state, that is, an arched state.

Japanese Patent Laid-open No. 63 (1988)-168594 states a jet pump for a boiling water reactor. This jet pump is provided with a riser pipe, an inlet mixer, and a diffuser. The inlet mixer has an elbow connected to the riser pipe, a nozzle connected to the elbow, a bell mouth disposed below the nozzle, and a throat provided to the lower end of the bell mouth. A transition piece having a pair of projecting portions between which the elbow installed to the riser pipe is disposed. The pair of projection portions faces each other. A beam is inserted to each groove formed in the pair of projecting portions. A tensioner is disposed between the beam and the top portion of the elbow and adds a deflection amount δ to the beam.

Japanese Patent No. 4052377 states a jet pump beam fixing apparatus. This jet pump beam fixing apparatus has a fixing apparatus that is attached to a jet pump beam. The fixing apparatus engages with ratchet teeth formed around a beam bolt which engages with the jet pump beam to fix the beam.

In a conventional method of installing a jet pump beam stated in Japanese Patent No. 4052377, the jet pump beam, each groove formed in a pair of projection portions installed on a transition piece, and a recess formed in the top portion of an elbow where the lower end portion of the beam bolt installed to the beam is inserted, are checked for the presence of a foreign object, and when a foreign object is found, it is removed. Then, the jet pump beam is inserted into each groove formed in the pair of projecting portions of the transition piece. The center portion of the jet pump beam is pulled with a tensioner to add a predetermined deflection amount to the jet pump beam before tightening the beam bolt.

The pushing force applied to the elbow, i.e., the inlet mixer by the jet pump beam is controlled generally by managing the water pressure of the tensioner and a clamping torque of the beam bolt, and an installation state after the installation of the jet pump beam is checked.

### CITATION LIST

### [Patent Literature]

[Patent Literature 1] Japanese Patent Laid-Open No. 63 (1988)-168594
[Patent Literature 2] Japanese Patent No. 4052377

### SUMMARY OF THE INVENTION

### Technical Problem

Since a deflection amount of the beam at the time of installation of the beam is generally as small as 0.5 mm or less, the deflection amount decreases if a foreign object gets into the joint between the beam and a lower end of the beam bolt during the installation. The decrease of the deflection amount may cause the elastic restorative force (pushing force) of the beam for resisting force exerted by a flowing fluid applied to the elbow to be insufficient. If the pushing force is not applied to the elbow by the beam, the inlet mixer, being unendurable to the force exerted by a flowing fluid, will float up, causing the consequent vibration of the inlet mixer to increase. For this reason, it is desirable that the pushing force applied to the inlet mixer by the beam be still more accurately checked.

It is an object of the present invention to provide a method of installing a jet pump beam that can check still more accurately pushing force added to an inlet mixer by the jet pump beam.

### Solution to Problem

The feature of the present invention for accomplishing the above object is a method of installing a jet pump beam comprising steps of:

disposing an inlet mixer, one end of which is inserted into a diffuser installed in a reactor pressure vessel and other end of which is communicated to a riser pipe disposed in the reactor pressure vessel, between a pair of projecting portions of a transition piece connected to the riser pipe;

separately inserting both end portions of a jet pump beam disposed above the inlet mixer into a groove formed in each of the pair of projecting portions,

arching the jet pump beam by moving a center portion of the jet pump beam upward;

pushing a screw member engaged with the arched jet pump beam against the inlet mixer; and

measuring deflection amount of the arched jet pump beam when the screw member is being pushed against the inlet mixer.

Since the deflection amount of the arched jet pump beam and both end portions of which are separately inserted into the groove formed in each of the pair of projecting portions when the screw member engaged with the jet pump beam is pushed against the inlet mixer, the pushing force added to the inlet mixer by the jet pump beam can be still more accurately checked.

### ADVANTAGEOUS EFFECT OF THE INVENTION

According to the present invention, the pushing force added to the inlet mixer by the jet pump beam can be still more accurately checked.

### BRIEF DESCRIPTION OF THE DRAWINGS

FIG. 1 is a flow chart showing process of a method of installing a jet pump beam according to embodiment 1, which is a preferred embodiment of the present invention.

FIG. 2 is an explanatory drawing showing a concept of deflection amount measurement of a jet pump beam shown in FIG. 1.

FIG. 3 is an explanatory drawing showing a specific example of deflection amount measurement of a jet pump beam shown in FIG. 1.

FIG. 4 is a side view showing a jet pump beam when deflection amount is being measured.

FIG. 5 is a longitudinal sectional view showing a boiling water reactor provided with a jet pump to which a method of installing a jet pump beam according to embodiment 1 is applied.

FIG. 6 is an enlarged view showing the jet pump shown in FIG.

FIG. 7 is a perspective view showing a vicinity of an elbow installed with the jet pump beam.

FIG. 8 is a cross-sectional view taken along VIII-VIII line of FIG. 7.

FIG. 9 is a front view showing a beam assembly having a jet pump beam.

FIG. 10 is an explanatory drawing showing deflection amount measurement of a jet pump beam in a method of installing a jet pump beam according to embodiment 2, which is another embodiment of the present invention.

FIG. 11 is an explanatory drawing showing deflection amount measurement of a jet pump beam in a method of installing a jet pump beam according to embodiment 3, which is another embodiment of the present invention.

FIG. 12 is an explanatory drawing showing deflection amount measurement of a jet pump beam in a method of installing a jet pump beam according to embodiment 4, which is another embodiment of the present invention.

FIG. 13 is an explanatory drawing showing deflection amount measurement of a jet pump beam in a method of installing a jet pump beam according to embodiment 5, which is another embodiment of the present invention.

FIG. 14 is an explanatory drawing showing deflection amount measurement of a jet pump beam in a method of installing a jet pump beam according to embodiment 6, which is another embodiment of the present invention.

FIG. 15 is an explanatory drawing showing deflection amount measurement of a jet pump beam in a method of installing a jet pump beam according to embodiment 7, which is another embodiment of the present invention.

### DETAILED DESCRIPTION OF THE PREFERRED EMBODIMENTS

Embodiments of the present invention will be described below.

### Embodiment 1

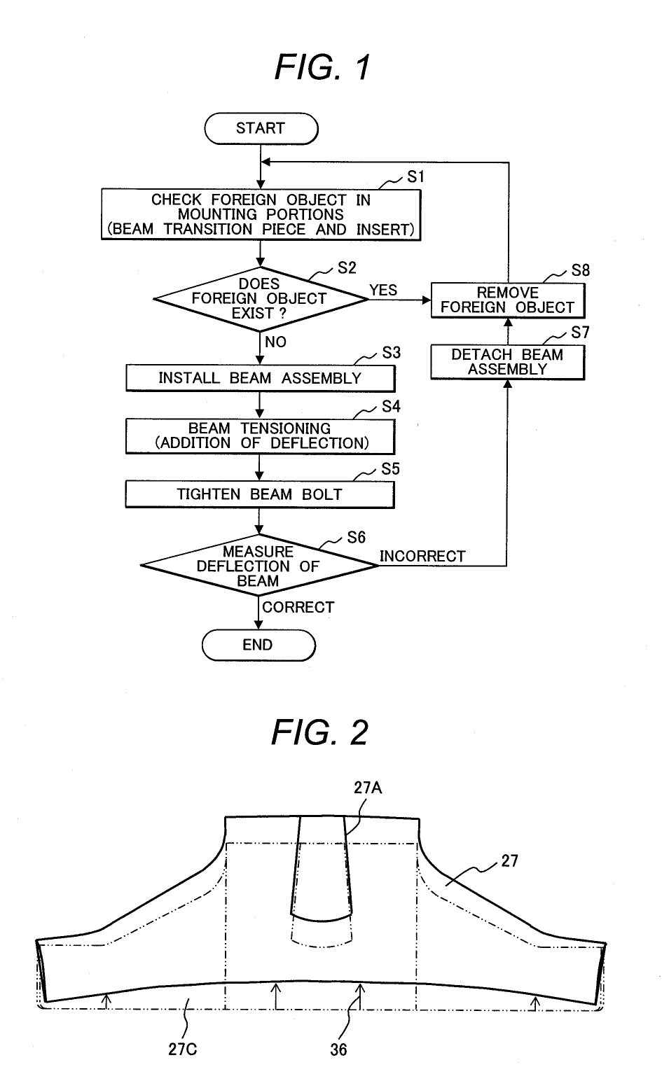

A method of installing a jet pump beam according to embodiment 1, which is a preferred embodiment of the present invention, will be described with reference to FIGS. 1 to 4.

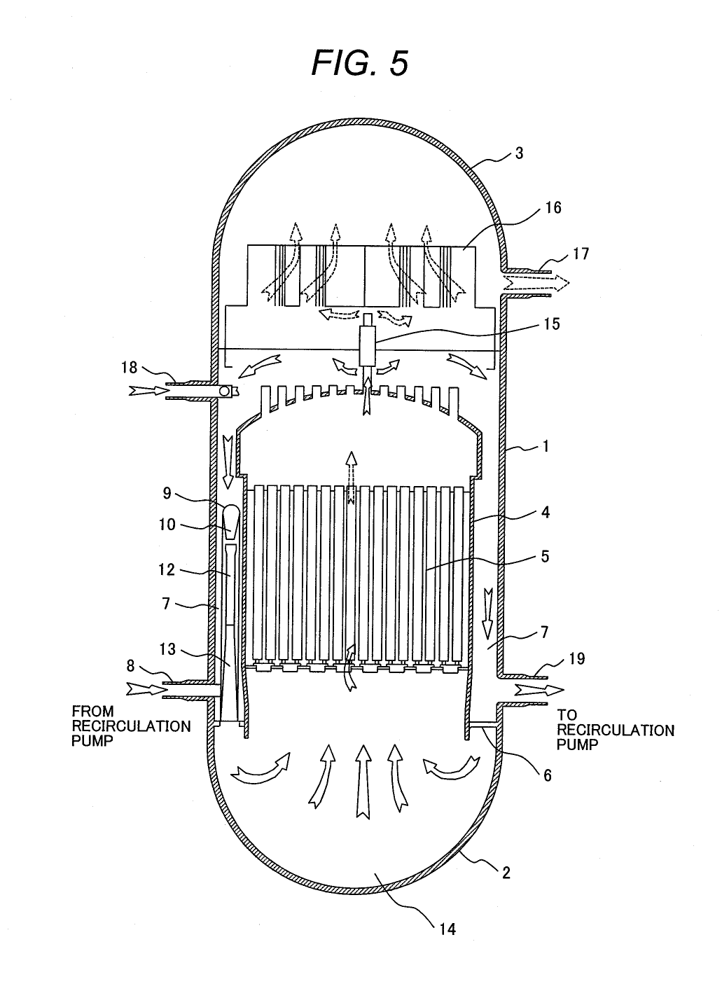

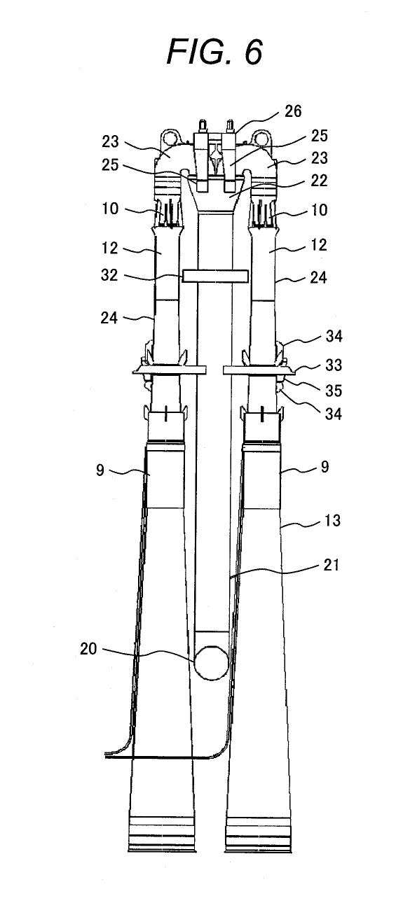

Before explaining the method of installing the jet pump beam according to the present embodiment, an overall structure of a boiling water reactor to which the jet pump is applied will be described below with reference to FIGS. 5 and 6.

The boiling water reactor (BWR) has a reactor pressure vessel 1 and is provided with a core shroud 4 in the reactor pressure vessel 1. The core shroud 4 is supported by a shroud support structure 6 installed to the inner surface of the reactor pressure vessel 1. The reactor pressure vessel is hereinafter referred to as the RPV. The RPV 1 has a bottom head 2, which is a bottom head, at a bottom and a removable top head (top cover) 3 at a top. A core 5 loaded with a plurality of fuel assemblies (not shown) is disposed in the core shroud 4. A steam separator 15 and a steam dryer 16 are disposed above the core 5 in the RPV 1.

A plurality of jet pumps 9 is disposed in an annular downcomer 7 formed between the RPV 1 and the core shroud 4, and is installed to the shroud support structure 6. A recirculation system provided to the RPV 1 has a recirculation pipe 19 and a recirculation pump (not shown) installed to the recirculation pipe 19. One end of the recirculation pipe 19 is connected to a nozzle of the RPV 1 and is communicated with the downcomer 7. The other end of the recirculation pipe 19 is connected to an entry nozzle 8 of the RPV 1 and is communicated with a riser elbow 20. The riser elbow 20 is connected to a lower end of a riser pipe 21 disposed in the downcomer 7 and an upper end of the riser pipe 21 is connected to a transition piece 22. The transition piece 22 is practically a part of the rise pipe 21.

The jet pump 9 has a diffuser 13 and an inlet mixer 24. The inlet mixer 24 has an elbow 23, a nozzle 10, a bell mouth and a throat 12 which are joined together as a single-piece construction. The transition piece 22 is connected to the elbow 23 of the jet pump 9. The other end of the elbow 23 is connected to the nozzle 10 and a flow passage is curved 180° at the elbow 23. The nozzle 10 is installed to the bell mouth by a plurality of support plates, and the throat 12 is connected to a lower end of the bell mouth. A lower end of the diffuser 13 is joined with the shroud support structure 6. The throat 12 and the diffuser 13 are connected with a slip joint. In the slip joint, a lower end portion of the throat 12 is inserted into an upper end portion of the diffuser 13.

A riser brace 32 installed to the inner surface of the RPV 1 and extending in a horizontal direction supports the riser pipe 21. A bracket 33 installed to the riser pipe 21 and extending in the horizontal direction holds each throat 12 of two jet pumps 9 located on both sides of the riser pipe 21. A support member 34 installed to the bracket 33 fixes the throat 12 disposed in the vertical direction.

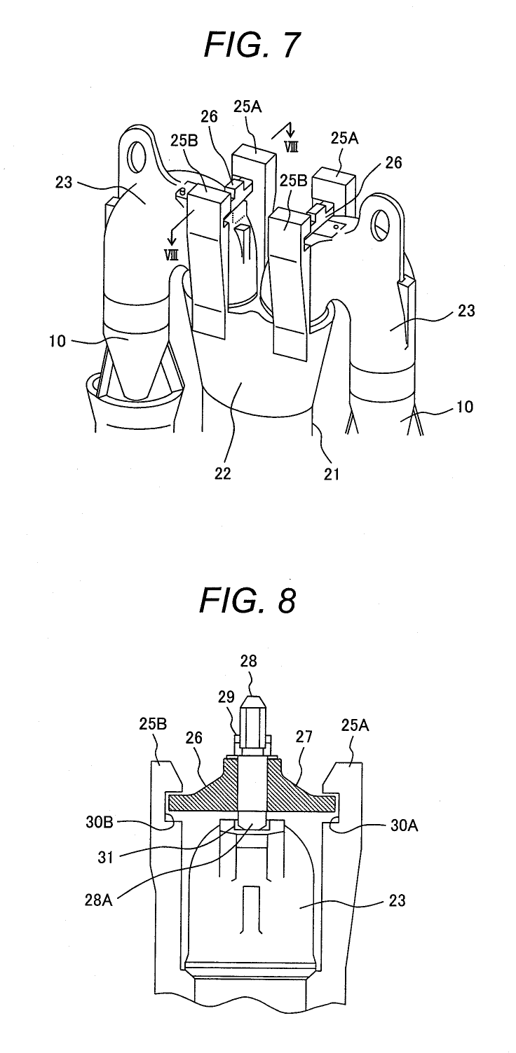

The transition piece 22 has a pair of projecting portions 25, that is, projecting portions 25A and 25B extending upward, and one elbow 23 connected to the transition piece 22 is disposed between the projecting portions 25A and 25B (see FIGS. 7 and 8). This elbow 23 is the elbow 23 of one of two jet pumps 9 communicated with one riser pipe 21. The other elbow 23 connected to the transition piece 22 is disposed between the other pair of projecting portions 25A and 25B of the transition piece 22 (see FIG. 7). This elbow 23 is the elbow 23 of the remaining jet pump 9 of the two jet pumps 9 described above. A driving water passage communicating each of the two elbows 23 and the riser pipe 21 is formed in the transition piece 22. A groove 30A extending in the horizontal direction is formed in each of the two projecting portions 25A, and a groove 30B extending in the horizontal direction and facing the groove 30A is formed in each of the two projecting portions 25B (see FIG. 8). A beam assembly 26 is inserted into the grooves 30A and 30B formed in the pair of opposing projecting portions 25A and 25B. The other beam assembly 26 is inserted into the grooves 30A and 30B formed in the other pair of opposing projecting portions 25A and 25B. By tightening a beam bolt 28 of the beam assembly 26, the inlet mixer 24 is pushed against the transition piece 22, that is, the riser pipe 21.

When maintenance and inspection are be performed, the beam assembly 26 is removed from the projecting portions 25A and 25B by loosening the beam bolt 28, and the support member 34 is removed from the bracket 33. Therefore, the inlet mixer 24 can be detached from the diffuser 13 and the riser pipe 21, that is, the transition piece 22.

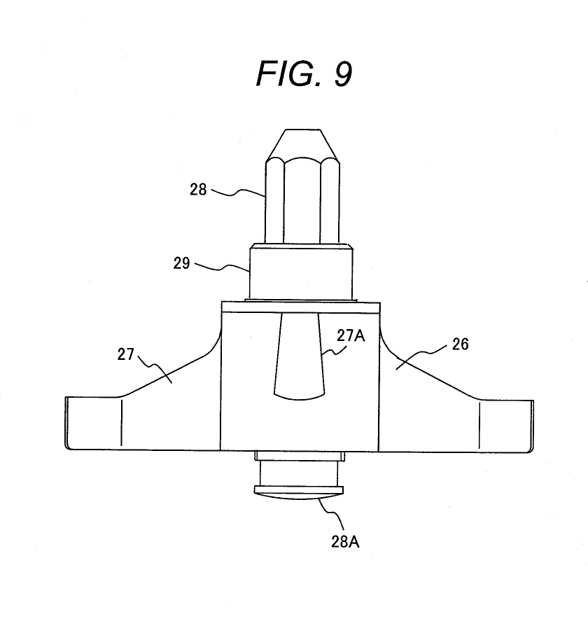

The beam assembly 26 will be described with reference to FIGS. 8 and 9. The beam assembly 26 has a jet pump beam (hereinafter, simply referred to as a beam) 27 and the beam bolt 28. The beam 27 has a length of the distance between a vertical surface of the groove 30A formed in the projecting portion 25A and a vertical surface of the groove 30B formed in the projecting portion 25B in the opposing projecting portions 25A and 25B. The beam 27 forms protrusion portions 27A and 27B extending in the horizontal direction on both side surfaces of the center portion in a longitudinal direction of the beam 27. The beam bolt 28 is installed in this center portion of the beam 27. The beam bolt 28 extends in the vertical direction and engages with a screw hole formed through the beam 27 in the vertical direction. A keeper 29 is provided to the top surface of the beam 27. Both end portions of the beam 27 are inserted into the groove 30A of the projecting portion 25A and the groove 30B of the projecting portion 25B facing each other.

Cooling water (a suction flow, coolant) which is suction water existing in an upper portion of the RPV 1 is mixed with feed water supplied into the RPV 1 from a feed water pipe 18 and flow down in the downcomer 7. The cooling water in the downcomer 7 is sucked into the recirculation pipe 19 by the drive of the recirculation pump and pressurized by the recirculation pump. This pressurized cooling water is referred to as driving water (a driving fluid) for convenience. The driving water flows through the recirculation pipe 19, the riser elbow 20, the riser pipe 21, the transition piece 22 and the elbow 23, reaches the nozzle 10 and is ejected from the nozzle 10 into the bell mouth and the throat 12. The cooling water which is suction water existing around the nozzle 10 in the downcomer 7 is sucked into the throat 12 through the bell mouth by the ejection of the driving water from the nozzle 10, passing through a cooling water passage formed between the nozzle 10 and the bell mouth. This cooling water flows down in the throat 12 with the driving water and discharged from the lower end of the diffuser 13. The cooling water discharged from the diffuser 13 is supplied to the core 5 through the lower plenum 14.

The cooling water is heated when passing the core 5 and becomes a gas-liquid two-phase flow including water and steam. The steam separator 15 separates the gas-liquid two-phase flow into steam and water. The separated steam, after the removal of moisture, is introduced into a main steam pipe 17. This steam is introduced to a steam turbine (not shown) through the main steam pipe 17 to rotate the steam turbine. A generator connected to the steam turbine is rotated and power is generated. The steam discharged from the steam turbine is condensed into water in a condenser (not shown). This condensed water is supplied into the RPV 1 as feed water through the feed water pipe 18. The water separated in the steam separator 15 and the steam dryer 16 falls to reach the downcomer 7 as cooling water.

The jet pump 9 having the elbow 23, the nozzle 10, the bell mouth, the throat 12, and the diffuser 13 as the main components, sucks the cooling water around the nozzle 10 so that a larger amount of cooling water can be sent into the core 5 with a smaller flow of driving water.

The beam 27 with a predetermined deflection amount adds pushing force to the elbow 23, pushing the elbow 23, i.e., the inlet mixer 24 to the riser pipe 21-side. To be more specific, the beam 27 adds the pushing force to the elbow 23 to which, force exerted by a flowing fluid is applied when the driving water flows through the elbow 23.

For example, when the vibration of the inlet mixer 24 is increased, the beam 27 may be exchanged to a new beam 27 during a periodic inspection of the boiling water reactor. Using a method of installing a jet pump beam used at this time as an example, the method of installing the jet pump beam of the present embodiment will be described. The beam bolt 28 is loosened and the beam 27 is withdrawn from the grooves 30A and 30B of the pair of projecting portions 25A and 25B. Then, the method of installing the jet pump beam of the present embodiment for installing a new beam 27 to the pair of projecting portions 25A and 25B will be performed. This installing method will be explained with reference to FIG. 1.

Whether a foreign object exists in mounting portions or not is checked (step S1). A worker inspects the grooves 30A and 30B of the projecting portions 25A and 25B where the new beam 27 is to be installed and a recess 31 formed in the top portion of the elbow 23 where an end 28A of the beam bolt 28 provided to the beam 27 is to be inserted. In addition, the worker inspects the surface of the installing beam 27 also. Whether a foreign object exists in or on them is determined (step S2). When it is determined that the foreign object is existed, the foreign object is removed from concerned region (for example, groove 30A and 30B and recess 31 and so on) (step S8). After the foreign object is removed, the check in the step S1 is performed again.

When it is determined in the step S2 that no foreign object exists, a beam assembly is installed (step S3). The beam assembly 26 (see FIG. 9), in which the beam bolt 28 is attached to the beam 27, is inserted in the pair of opposing projecting portions 25A and 25B. The beam assembly 26 has the keeper 29. One end portion of the beam 27 of the beam assembly 26 is fitted into the groove 30A of the projecting portion 25A and the other end portion of the beam 27 is fitted into the groove 30B of the projecting portion 25B facing the projecting portion 25A. Then, the beam 27 is moved horizontally along the grooves 30A and 30B and both end portions of the beam 27 are positioned to the predetermined locations in the grooves 30A and 30B. Beam tensioning (addition of deflection) is performed (step S4). A tensioner (not shown) is attached to the protrusions 27A and 27B of the beam 27 and then, a center portion of the beam 27 in the longitudinal direction of the beam 27 is upwardly pulled by the tensioner. Since both end portions of the beam 27 are fitted into the grooves 30A and 30B, as shown in FIG. 2, the beam 27 deforms into a state, in which the deflection is added, shown in a solid line and forced by the tensioner, from a state of 27C shown in a chain double-dashed lines, which before the deflection is added to the beam by the tensioner, so that an upward displacement 36 at the center portion of the beam 27 in the longitudinal direction of the beam 27 becomes larger compared to the end portions of the beam 27. Consequently, the deflection is added to the beam 27 in the longitudinal direction of the beam 27, as shown in the solid line in FIG. 2. The displacement 36 is created by the addition of the deflection against the beam 27 in the step S4.

Then, the beam bolt is tightened (step S5). While the beam 27 is being pulled up by the tensioner, the beam bolt 28 engaged with a screw hole formed through the beam 27 in the vertical direction is tightened. The bolt 28 is tightened until the lower end 28A of the beam bolt 28 comes in contact with the bottom of the recess 31. After the beam bolt 28 is completely tightened, the tensioner is removed from the protrusions 27A and 27B. Even after the tensioner is removed, since the end 28A of the beam bolt 28 engaged with the beam 27 is in contact with the bottom surface of the recess 31 formed in the elbow 23, the deflection added to the beam 27 in the step S4 is maintained. The deflection of the beam 27 is measured (step S6).

The overview of measuring the deflection amount of the beam 27 will be described with reference to FIG. 2. When the deflection is added to the beam 27 by the tensioner, since both end portions of the beam 27 are fitted into the grooves 30A and 30B of the projecting portions 25A and 25B as described above, the displacement 36 in the vertical direction at the center portion of the beam 27 in the longitudinal direction of the beam 27 will be larger than the displacement at the both end portions of the beam 27. Because of this, a difference between the displacement of the beam 27 in the vertical direction at the center portion of the beam 27 in the longitudinal direction of the beam and the displacement of the beam 27 in the vertical direction at the end portion can be calculated to obtain the amount of displacement, that is, the deflection amount at the center portion of the beam 27. This obtained deflection amount can be compared, for example, with deflection amounts obtained by analysis and testing. Based on a result of this comparison, the correctness of the tightening condition of the beam bolt 28 can be checked.

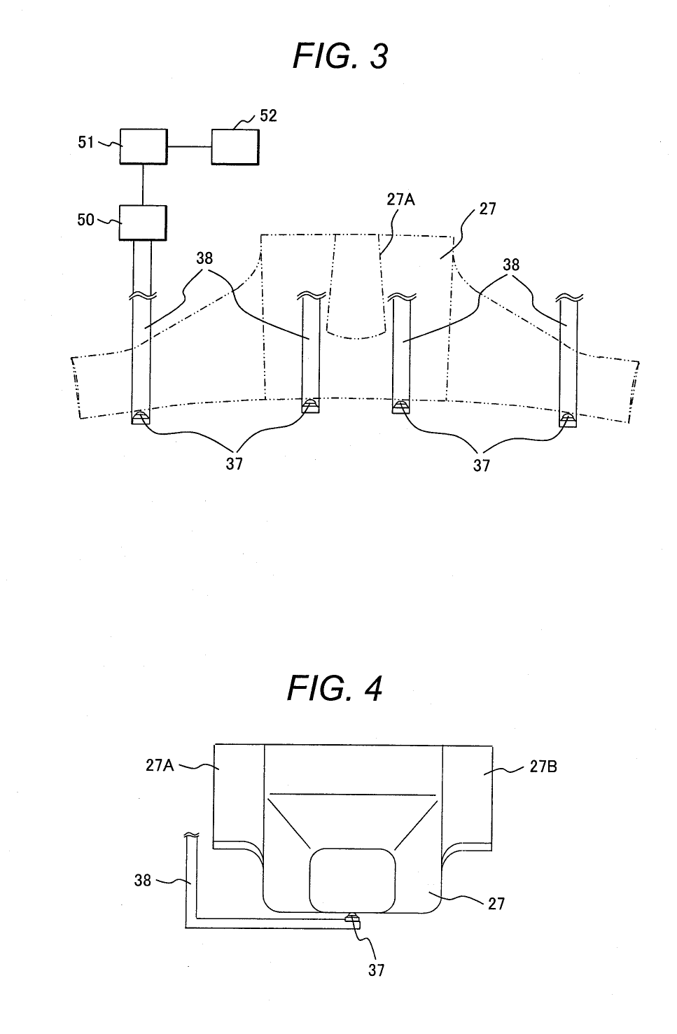

The measurement of the deflection of the beam 27 performed in the present embodiment will be described with reference to FIGS. 3 and 4. The deflection amount of the beam 27 is measured using a measuring arm 38 attached to a contact 37. The measuring arm 38 is bent at a right angle as shown in FIG. 4 and has a horizontal portion and a vertical portion connected to the horizontal portion. The contact 37 is fixed to a top surface of the horizontal portion. A displacement meter 50 is attached to the vertical portion of the measuring arm 38. While the beam 27 is fitted into the grooves 30A and 30B of the projecting portions 25A and 25B and attached to the projecting portions 25A and 25B, the horizontal portion of the measuring arm 38 is inserted between the beam 27 and the elbow 23 so as to make the surface installed with the contact 37 face up and to position the contact 37 directly below the underside of the beam 27. The measuring arm 38 is moved upward until the contact 37 is come in contact with the underside of the beam 27 and a displacement amount (a deflection amount) of the underside in the vertical direction is measured. This displacement amount in the vertical direction is a displacement amount from a reference point, which is obtained by calculating the moved amount of the measuring arm 38 in the axial direction of the beam bolt 28 using the displacement meter 50. The displacement amount of the underside of the beam 27 in the vertical direction is, as shown in FIG. 3, measured at four locations at predetermined intervals in the longitudinal direction of the beam 27 (for example, two locations in the center portion in the longitudinal direction of the beam 27 and one location at each of the end portions of the beam 27). The displacement amount measured by the displacement meter 50 is inputted into an arithmetic apparatus 51 and stored in a memory (not shown) of the arithmetic apparatus 51. The displacement amounts of the beam 27 are measured at the above four locations by moving one measuring arm 38 in the longitudinal direction of the beam 27. Four vertically movable measuring arms 38 may be installed to a single support member, in which case, each horizontal portion of the arms may be inserted between the beam 27 and the elbow 23, and these measuring arms 38 may be sequentially moved upward until each contact 37 provided to the measuring arms 38 are come in contact with the underside of the beam 27 for measuring the displacement at each location.

After the beam assembly is installed (step S3) but before the deflection is added to the beam 27 (step S4), the displacement amount of the underside of the beam 27 in the axial direction of the beam bolt 28 is measured using the measuring arm 38 and the displacement meter 50, in the same manner as in the step S6, at the same locations in the longitudinal direction of the beam 27 where the displacement amount of the underside of the beam 27 in the axial direction of the beam bolt 28 is measured in the step S6. The displacement amounts measured here are displacement amounts before the deflection is added to the beam 27, and the amounts are stored in the memory of the arithmetic apparatus 51. The arithmetic apparatus 51 obtains the deflection amount based on the deflection added to the beam 27 in the step S4 by subtracting the displacement amount of the underside of the beam 27 before the deflection is added to the beam 27 from the displacement amount of the underside of the beam 27 after the deflection is added to the beam 27. This deflection amount is obtained at each of the above-described four locations in the longitudinal direction of the beam 27.

After each deflection amount is obtained, the arithmetic apparatus 51 compares each deflection amount obtained in the step S6 to a set value for each of them to determine whether each deflection amount at the four locations in the longitudinal direction of the beam 27 is equal to the set value for each of them. These determination results are outputted from the arithmetic apparatus 51 to a display apparatus 52, and displayed on the display apparatus 52.

When the arithmetic apparatus 51 determines in the step S6 that the deflection amount of the beam 27 is not equal to the set value, the display apparatus 52 displays “the deflection amount of the beam is incorrect”. When this is displayed, a worker detaches the beam assembly 26 from the projecting portions 25A and 25B (step S7) and removes any foreign object from concerned region (step S8). Then, each process of the steps S1 to S6 is performed, and when it is determined in the step S6 that “the deflection amount of the beam is correct”, the keeper 29 for stopping rotation is welded to the beam 27 and the beam bolt 28, and all the processes of the method installing of the jet pump beam in the present embodiment are completed.

The process performed by the arithmetic apparatus 51 may be performed by a worker based on the measured values from the displacement meter 50 without using the arithmetic apparatus 51 and the display apparatus 52.

Instead of using the displacement amounts of the underside of the beam 27 before and after the deflection is added to the beam 27, as described above, a difference between the displacement amounts in the axial direction of the beam bolt 28 at the end portion and at the center portion of the beam 27 after the deflection is added to the beam 27 may be used for the arithmetic apparatus 51 to obtain a deflection amount of the beam 27 in the axial direction.

According to the present embodiment, the deflection amount of the beam 27 installed to the projecting portions 25A and 25B provided to the transition piece 22 is measured so that the pushing force added to the inlet mixer 24 by the beam 27 can be still more accurately checked. Thus, still more appropriate pushing force can be added to the inlet mixer 24, and the vibration of the inlet mixer during the operation of the boiling water reactor can be further decreased.

In all of the present embodiment and embodiments 2, 3, and 5 to be described later, the displacement 36 of the beam 27 is measured while the deflection is added to the beam, and based on this displacement 36, the deflection amount of the beam 27 is obtained.

### Embodiment 2

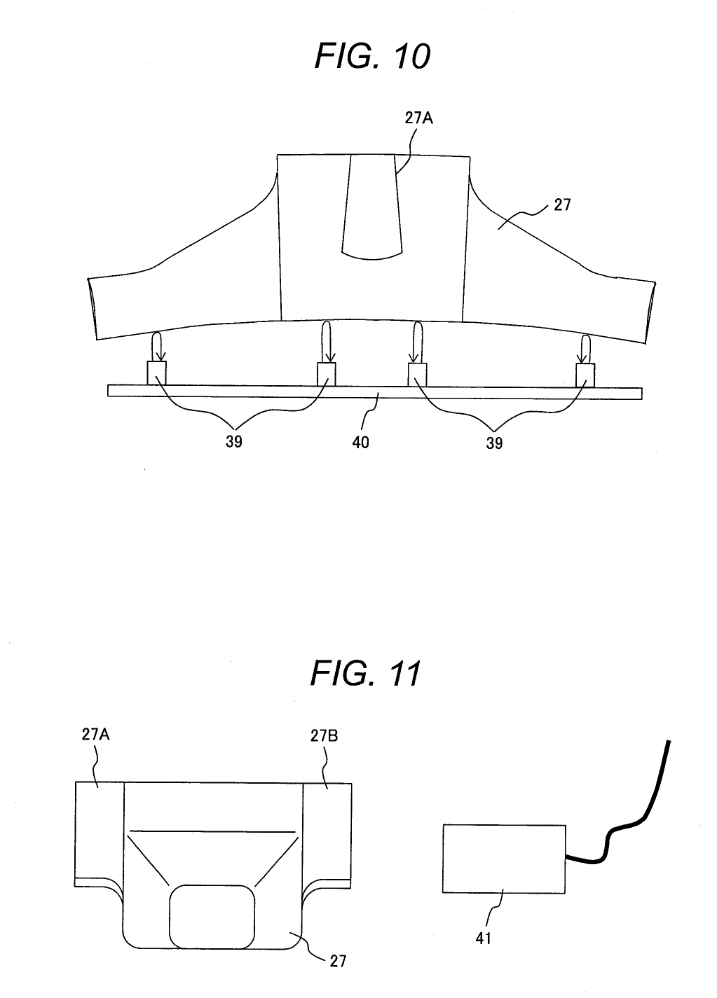

A method of installing a jet pump beam according to embodiment 2, which is another embodiment of the present invention, will be described with reference to FIG. 10.

In the method of installing the jet pump beam of the present embodiment, each process of the steps S1 to S5, S7, and S8, shown in FIG. 1, performed in the embodiment 1 is executed. In the present embodiment, the process of the step S6 is different from the embodiment 1. The present embodiment uses a measuring apparatus shown in FIG. 10 for measuring the deflection of the beam 27 in the step S6. This measuring apparatus has a plurality of (for example, four) laser transmitters/receivers 39 installed on a long support member 40. The intervals between the laser transmitters/receivers 39 installed on the support member 40 are set to the intervals of the plurality of deflection measurement locations in the longitudinal direction of the beam 27, which is the target of measurement.

The support member 40 installed with the four laser transmitters/receivers 39 is inserted between the elbow 23 and the beam 27, to which the deflection is added, attached to the projecting portions 25A and 25B. While the levelness of the support member 40 is maintained, a laser is sent from each laser transmitter/receiver 39 to the measurement location of the underside of the beam 27 to which the deflection is added. The sent laser reflects on the underside of the beam 27 and is received by each laser transmitter/receiver 39. Each laser transmitter/receiver 39 inputs the time the laser is sent and the time the reflected laser is received into an arithmetic apparatus (not shown). The arithmetic apparatus calculates a difference between the sent time of the laser and the received time of the reflected laser, and based on the time difference and the transmission speed of the laser in air, calculates the first distance between the laser transmitter/receiver 39 and the underside of the beam 27 where the laser is reflected at each location. In the same manner, the second distance between the laser transmitter/receiver 39 and the underside of the beam 27 where the laser is reflected at each location before the deflection is added to the beam is calculated. The arithmetic apparatus obtains a deflection amount in the axial direction of the beam volt 28 at each of the four locations of the beam 27 based on the first distance and the second distance.

When the obtained deflection amount satisfies a set value, the method of installing the jet pump beam of embodiment 2 is completed. When the obtained deflection amount does not satisfy the set value, each process of the steps S7, S8, and S1 to S6 shown in FIG. 1 is performed.

Each effect achieved in embodiment 1 can be obtained in the present embodiment. In the present embodiment, unlike embodiment 1, lasers can be sent from the plurality of laser transmitters/receivers 39 simultaneously to the plurality of measurement locations of the underside of the beam 27, thus the time required for measuring the deflection amount of the beam 27 can be reduced by more than in embodiment 1.

In the same manner as in embodiment 1, the deflection amount of the beam 27 can be obtained based on a distance between the center portion of the beam 27 and the laser transmitter/receiver 39 after the deflection is added to the beam and a distance between the end portion of the beam 27 and the laser transmitter/receiver 39 after the deflection is added to the beam.

A measuring apparatus installed with a plurality of ultrasonic transmitter/receiver on the support member 40, in place of the laser transmitter/receiver 39, may be used to measure deflection amounts at a plurality of locations of the beam 27 as in the same manner as using the laser.

### Embodiment 3

A method of installing a jet pump beam according to embodiment 3, which is another embodiment of the present invention, will be described with reference to FIG. 11.

In the method of installing the jet pump beam of the present embodiment, each process of the steps S1 to S5, S7, and S8, shown in FIG. 1, performed in embodiment 1 is executed. In the present embodiment, the process of the step S6 is different from embodiment 1. The present embodiment uses a camera 41 shown in FIG. 11 for measuring the arching of the beam 27 in the step S6.

A front of the beam 27, to which the deflection is added, installed to the projecting portions 25A and 25B is taken by the camera 41. The image signals of the front of the beam 27 taken by the camera 41 are inputted into an image processing apparatus (not shown). The camera 41 takes front images of the beam 27 before and after the deflection is added to the beam 27, and each image is inputted into the image processing apparatus. In the step S6, image data of those two images are compared in the image processing apparatus, and a deflection amount at each location of the underside of the beam 27 is obtained based on the image data of the two images. The deflection amount of the beam 27 may be obtained by using only the image data of the beam 27 after the deflection is added to the beam 27 based on the image data of the center portion of the beam 27 in the longitudinal direction of the beam 27 and the end portion of the beam 27.

When the obtained deflection amount satisfies a set value, the method of installing a jet pump beam of embodiment 3 is completed. Otherwise, each process of the steps S7, S8, and S1 to S6 shown in FIG. 1 is performed.

Each effect achieved in embodiment 1 can be obtained in the present embodiment. In the present embodiment, unlike embodiment 1, the deflection amount is obtained based on the image signals taken by the camera 41, thus the time required for measuring the deflection amount of the beam 27 can be reduced by more than in embodiment 1. The camera 41 can be installed to the projecting portion 25 or the beam bolt 28 to improve detection sensitivity. The camera 41 installed to the projecting portion 25 or the beam bolt 28 can prevent shakiness during shooting so that clear images can be obtained. For this reason, the sensitivity in detecting the deflection amount can be improved.

### Embodiment 4

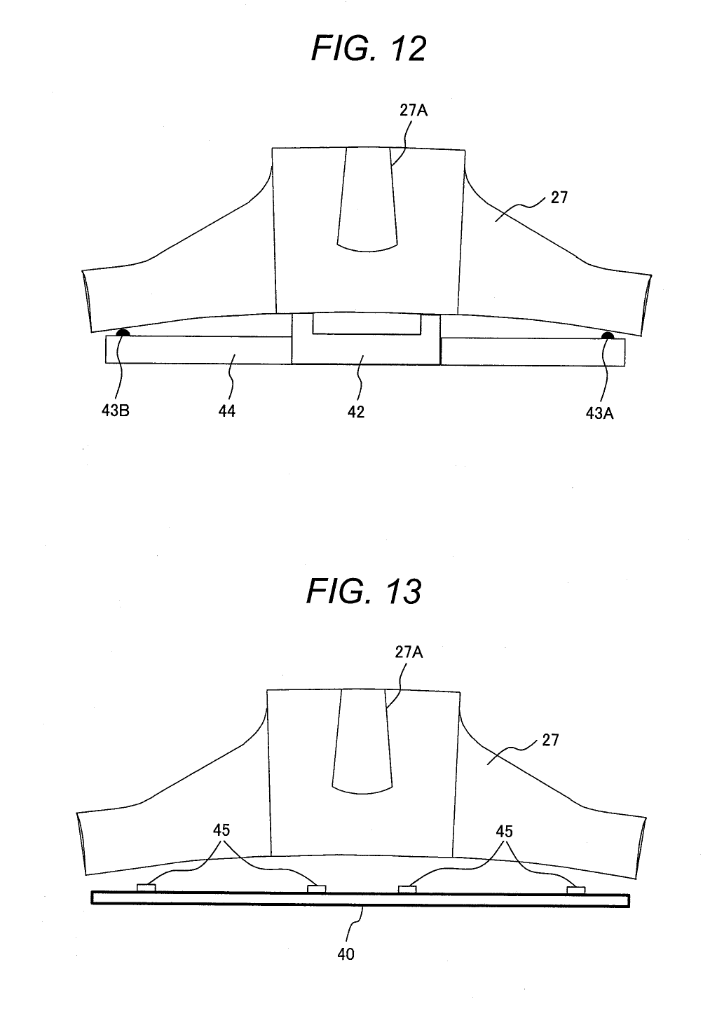

A method of installing a jet pump beam according to embodiment 4, which is another embodiment of the present invention, will be described with reference to FIG. 12.

In the method of installing the jet pump beam of the present embodiment, each process of the steps S1 to S5, S7, and S8, shown in FIG. 1, performed in embodiment 1 is executed. In the present embodiment, the process of the step S6 is different from embodiment 1. The present embodiment uses a measuring apparatus shown in FIG. 12 for measuring the deflection of the beam 27 in the step S6. This measuring apparatus has an electric insulator 42, a pair of long support members 44 installed on both sides of the electric insulator 42, an electrode terminal 43A provided to one of the support members 44, and an electrode terminal 43B provided to the other support member 44. The electrode terminals 43A and 43B are installed on the top surface of the support members 44, and the measurement between the top surface of the insulator and the top surface of the support member 44 is equal to the deflection amount when the deflection amount of the beam 27 at the center portion of the beam 27 in the longitudinal direction of the beam 27 is a set value. In the longitudinal direction, the measurement between the electrode terminal 43A and the side surface of the electric insulator 42 facing the electrode terminal 43A is equal to the measurement between the electrode terminal 43B and the side surface of the electric insulator 42 facing the electrode terminal 43B.

The electrode terminals 43A and 43B are each connected to a power source with wiring, and a switch and an ammeter are serially connected to the wiring connecting one of the electrode terminals and the power source. Since the electric insulator 42 is provided, the electrode terminals 43A and 43B will not conduct electricity through the support members 44.

In the step S6, the above measuring apparatus is inserted between the beam 27 and the elbow 23, and the measuring apparatus is moved upward until the top surface of the electric insulator 42 comes in contact with the underside of the beam 27 at the center portion of the beam 27 in the longitudinal direction of the beam 27. When the top surface of the electric insulator 42 comes in contact with the underside of the beam 27 at the center portion of the beam 27 in the longitudinal direction of the beam 27, the switch is closed. In this state, when the electrode terminals 43A and 43B come in contact with the underside of the beam 27, current supplied from the power source passes through the electric terminal 43A, the beam 27, and the electric terminal 43B. This current flow can be measured by the ammeter connected to the wiring. When current is measured by the ammeter, the deflection amount of the beam 27 is equal to the set value and the determination result of the step S6 will show “the deflection amount of the beam is correct”. At this time, the method of installing the jet pump beam of embodiment 4 is completed.

When the deflection amount of the beam 27 is not equal to the set value, at least one of the electrode terminals 43A and 43B does not come in contact with the underside of the beam 27 even when the top surface of the electric insulator 42 comes in contact with the underside of the center portion of the beam 27. No current passes through the ammeter in this case. This state is shown as “the deflection amount of the beam is incorrect”, thus each process of the steps S7, S8, and S1 to S6 shown in FIG. 1 is performed.

Each effect achieved in embodiment 1 can be obtained in the present embodiment. In the present embodiment, the time required for measuring the deflection amount of the beam 27 can be reduced by more than in embodiment 1.

### Embodiment 5

A method of installing a jet pump beam according to embodiment 5, which is another embodiment of the present invention, will be described with reference to FIG. 13.

In the method of installing the jet pump beam of the present embodiment, each process of the steps S1 to S5, S7, and S8, shown in FIG. 1, performed in embodiment 1 is executed. In the present embodiment, the process of the step S6 is different from embodiment 1. The present embodiment uses a measuring apparatus shown in FIG. 13 for measuring the deflection of the beam 27 in the step S6. This measuring apparatus has a plurality of electromagnetic induction sensors 45 installed on the top surface of the support member 40. These electromagnetic induction sensors 45 are disposed corresponding to a plurality of locations for measuring the deflection amount of the underside of the beam 27 to which the deflection is added.

This measuring apparatus is inserted between the elbow 23 and the arched beam 27, to which the deflection is added, attached to the projecting portions 25A and 25B so that each electromagnetic induction sensor 45 faces the underside of the beam 27. Current is supplied to each magnetic induction sensor 45. Strength of output signal of the electromagnetic induction sensor 45 varies according to the distance between the electromagnetic induction sensor 45 and the underside of the beam 27. The output signal of each electromagnetic induction sensor 45 is inputted into an arithmetic apparatus (not shown). The arithmetic apparatus obtains each distance between the electromagnetic induction sensor 45 and the underside of the beam 27 based on the strength of the output signal of each electromagnetic induction sensor 45 inputted. In the same manner, each distance between the electromagnetic induction sensor 45 and the underside of the beam 27 is obtained for the beam 27 after it is attached to the projecting portions 25A and 25B but before the deflection is added to the beam 27. The arithmetic apparatus obtains the deflection amount at each location in the longitudinal direction of the beam 27 attached to the projecting portions 25A and 25B using the distances between the electromagnetic induction sensor 45 and the underside of the beam 27 before and after the deflection is added to the beam 27.

When the determination result of the step S6 is “the deflection amount of the beam is correct”, the method of installing the jet pump beam of embodiment 5 is completed. When the deflection amount of the beam 27 is not equal to a set value, the result shows “the deflection amount of the beam is incorrect”, then, each process of the steps S7, S8, and S1 to S6 shown in FIG. 1 is performed.

Each effect achieved in embodiment 1 can be obtained in the present embodiment. In the present embodiment, the time required for measuring the deflection amount of the beam 27 is reduced by more than in embodiment 1.

### Embodiment 6

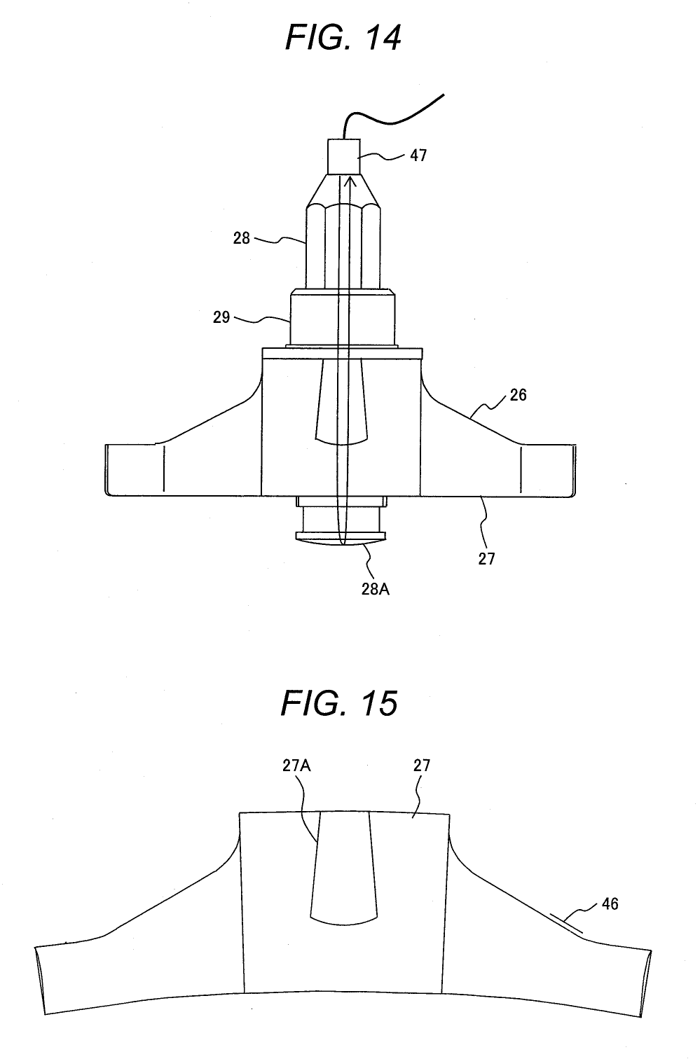

A method of installing a jet pump beam according to embodiment 6, which is another embodiment of the present invention, will be described with reference to FIG. 14.

In the method of installing the jet pump beam of the present embodiment, each process of the steps S1 to S5, S7, and S8, shown in FIG. 1, performed in embodiment 1 is executed. In the present embodiment, the process of the step S6 is different from embodiment 1. The present embodiment uses an ultrasonic transmitter/receiver 47 shown in FIG. 14 for measuring the deflection of the beam 27 in the step S6. In the present embodiment, when the deflection amount of the beam 27 is to be measured in the step S6, the ultrasonic transmitter/receiver 47 is come in contact with the top surface of the beam bolt 28.

When the pushing force applied to the inlet mixer 24 is appropriately added by the deflection of the beam 27, the same value of compressive force is applied to the beam bolt 28. Thus, by measuring the compressed amount of the beam bolt 28, the pushing force by the deflection of the beam 27 to the inlet mixer 24, that is, the deflection amount added to the beam 27 can be measured.

The compressed amount of the beam bolt 28 can be obtained by measuring the lengths of the beam bolt 28 before and after the deflection is added to the beam 27. The length of the beam bolt 28 in the axial direction can be measured using the ultrasonic transmitter/receiver 47.

The ultrasonic transmitter/receiver 47 is come in contact with the top surface of the beam bolt 28 attached to the beam 27 to which the deflection is added, and then, an ultrasonic wave is entered into the beam bolt 28 from the ultrasonic transmitter/receiver 47. This ultrasonic wave travels through the beam bolt 28 in the axial direction and is reflected at the end 28A contacting the bottom of the recess 31. The reflected wave reflected at the end 28A travels back through the beam bolt 28 and is received by the ultrasonic transmitter/receiver 47. After the reflected wave signal received by the ultrasonic transmitter/receiver 47 is changed to a digital signal, it is inputted into an arithmetic apparatus (not shown). The arithmetic apparatus measures the length of the beam bolt 28 in the axial direction while the deflection is added to the beam 27, based on a difference between the time the ultrasound wave is sent from the ultrasonic transmitter/receiver 47 and the time it is received by the ultrasonic transmitter/receiver 47 and speed of the ultrasonic wave traveling through the beam bolt 28. The length in the axial direction of the beam bolt 28 attached to the beam 27 before the deflection is added to the beam is obtained by the arithmetic apparatus in the same manner. The arithmetic apparatus calculates the compressed amount in the axial direction of the beam bolt 28 attached to the beam 27, to which the deflection is added, by subtracting the length in the axial direction of the beam bolt 28 attached to the beam 27, to which the deflection is added, from the length in the axial direction of the beam bolt 28 attached to the beam 27 before the deflection is added to the beam. The calculated compressed amount is the deflection amount of the beam 27 to which the deflection is added, in the present embodiment.

When the calculated compressed amount is equal to a set value in the step S6, a determination result is “the deflection amount of the beam is correct”. At this time, the method of installing the jet pump beam of embodiment 6 is completed. When the calculated compressed amount is less than the set value, the determination result is “the deflection amount of the beam is incorrect”, then, each process of the steps S7, S8, and S1 to S6 shown in FIG. 1 is performed.

Each effect achieved in embodiment 1 can be obtained in the present embodiment. In the present embodiment, the time required for measuring the deflection amount of the beam 27 is reduced by more than in embodiment 1.

### Embodiment 7

A method of installing a jet pump beam according to embodiment 7, which is another embodiment of the present invention, will be described with reference to FIG. 15.

In the method of installing the jet pump beam of the present embodiment, each process of the steps S1 to S5, S7, and S8, shown in FIG. 1, performed in embodiment 1 is executed. In the present embodiment, the process of the step S6 is different from embodiment 1. The present embodiment uses a strain gauge (a strain measuring apparatus) 46 shown in FIG. 15 for measuring the deflection of the beam 27 in the step S6. The strain gauge 46 is placed on the top surface of the beam 27 attached to the projecting portions 25A and 25B. The strain gauge 46 may be laced on the underside or the side surface of the beam 27, or on the beam bolt 28.

In the step S6, strain generated in the beam 27, to which the deflection is added, is measured by the strain gauge 46. An arithmetic apparatus (not shown) inputs the output signal of the strain gauge 46, obtains the strain generated in the beam 27, and calculates the deflection amount of the beam 27 from the obtained strain.

When the calculated deflection amount is equal to a set value in the step S6, a determination result is “the deflection amount of the beam is correct”. At this time, the method of installing the jet pump beam of embodiment 7 is completed. When the calculated deflection amount is less than the set value, the determination result is “the deflection amount of the beam is incorrect”, then, each process of the steps S7, S8, and S1 to S6 shown in FIG. 1 is performed.

Each effect achieved in embodiment 1 can be obtained in the present embodiment. In the present embodiment, the time required for measuring the deflection amount of the beam 27 is reduced by more than in embodiment 1.

Without using the strain gauge 46, the strain of the beam 27 can be measured by applying a laser strain measurement method, the Moiré method, and the like.

### REFERENCE SIGNS LIST

1: reactor pressure vessel, 4: core shroud, 5: core, 9: jet pump, 10: nozzle, 12: throat, 13: diffuser, 21: riser pipe, 22: transition piece, 23: elbow, 24: inlet mixer, 25, 25A, 25B: projecting portion, 26: beam assembly, 27: jet pump beam, 28: beam volt, 30A, 30B: groove, 37: contact, 38: measuring arm, 39: laser transmitter/receiver, 40, 44: support member, 41: camera, 42: electric insulator, 43A, 43B: electrode terminal, 45: electromagnetic induction sensor, 46: strain gauge.

What is claimed is:

1. A method of installing a jet pump beam, comprising steps of:
disposing an inlet mixer, one end portion of which is inserted to a diffuser provided in a reactor pressure vessel and the other end portion of which is communicated with a riser pipe disposed in the reactor pressure vessel, between a pair of projecting portions of a transition piece provided to the riser pipe;
separately inserting both end portions of a jet pump beam disposed above the inlet mixer into a groove formed in each of the pair of projecting portions;
arching the jet pump beam by moving a center portion of the jet pump beam upward;
pushing a screw member engaged with the arched jet pump beam against the inlet mixer; and
measuring deflection amount of the arched jet pump beam when the screw member is being pushed against the inlet mixer.

2. The method of installing a jet pump beam according to claim 1, wherein whether the measured deflection amount is equal to a set value or not is determined.

3. The method of installing a jet pump beam according to claim 1, wherein the deflection amount is obtained based on a first displacement of the jet pump beam after the deflection is added to the beam and a second displacement of the jet pump beam before the deflection is added to the beam.

4. The method of installing a jet pump beam according to claim 3, wherein the first displacement and the second displacement are obtained based on image information of the jet pump beam taken by a camera.

5. The method of installing a jet pump beam according to claim 3, wherein the first displacement and the second displacement are obtained based on a distance between a distance measuring apparatus and an underside of the jet pump beam, measured by the distance measuring apparatus.

6. The method of installing a jet pump beam according to claim 2, wherein the deflection amount is obtained based on a first displacement of the jet pump beam after the deflection is added to the beam and a second displacement of the jet pump beam before the deflection is added to the beam.

7. The method of installing a jet pump beam according to claim 6, wherein the first displacement and the second displacement are obtained based on image information of the jet pump beam taken by a camera.

8. The method of installing a jet pump beam according to claim 6, wherein the first displacement and the second displacement are obtained based on a distance between a distance measuring apparatus and an underside of the jet pump beam, measured by the distance measuring apparatus.

9. The method of installing a jet pump beam according to claim 1, wherein the deflection amount is obtained based on a first displacement at a center portion of the jet pump beam, to which the deflection is added, in the longitudinal direction of the jet pump beam and a second displacement at an end portion of the jet pump beam, to which the deflection is added, in the longitudinal direction of the jet pump beam.

10. The method of installing a jet pump beam according to claim 9, wherein the first displacement and the second displacement are obtained based on image information of the jet pump beam taken by a camera.

11. The method of installing a jet pump beam according to claim 9, wherein the first displacement and the second displacement are obtained based on a distance between a distance measuring apparatus and an underside of the jet pump beam, measured by the distance measuring apparatus.

12. The method of installing a jet pump beam according to claim 2, wherein the deflection amount is obtained based on a first displacement at a center portion of the jet pump beam, to which the deflection is added, in the longitudinal direction of the jet pump beam and a second displacement at an end portion of the jet pump beam, to which the deflection is added, in the longitudinal direction of the jet pump beam.

13. The method of installing a jet pump beam according to claim 12, wherein the first displacement and the second displacement are obtained based on image information of the jet pump beam taken by a camera.

14. The method of installing a jet pump beam according to claim 12, wherein the first displacement and the second displacement are obtained based on a distance between a distance measuring apparatus and an underside of the jet pump beam, measured by the distance measuring apparatus.

15. The method of installing a jet pump beam according to claim 1, wherein a compressed amount of the screw member is measured and the deflection amount is obtained based on the compressed amount of the screw member.

16. The method of installing a jet pump beam according to claim 2, wherein a compressed amount of the screw member is measured and the deflection amount is obtained based on the compressed amount of the screw member.

17. The method of installing a jet pump beam according to claim 1, wherein the deflection amount is obtained based on strain measured by a strain measuring apparatus attached to either the jet pump beam or the screw member.

18. The method of installing a jet pump beam according to claim 2, wherein the deflection amount is obtained based on strain measured by a strain measuring apparatus attached to either the jet pump beam or the screw member.

19. The method of installing a jet pump beam according to claim 1, wherein, a top surface of an electric insulator of a measuring apparatus having the electric insulator, a pair of support members attached to the electric insulator and extending toward an opposite direction from the electric insulator, and an electrode terminal attached to each end portion of the support members, is come in contact with an underside of the jet pump beam; current is supplied to each electrode terminal when the top surface of the electric insulator is come in contact with an underside of the jet pump beam; and when the current is passed between the electrode terminals, it is determined that the deflection amount is correct in the measurement of the deflection amount.
